(19) United States
(12) Patent Application Publication
(10) Pub. No.: US 2007/0008104 A1
(43) Pub. Date: Jan. 11, 2007

(54) Emergency alert delivery system

(76) Inventor: Theodore McBain, Tahoe City, CA (US)

Correspondence Address: THEODORE McBAIN, P.O. BOX 775, TAHOE CITY, CA, 96145, US

(21) Appl. No.: 10/997,872

(22) Filed: Jun. 13, 2005

(51) Int. Cl. G08B 23/00

(52) U.S. Cl. 340/517

(57) ABSTRACT

Disclosed is a method for sending, receiving and decoding emergency alert signals for local regional county and statewide EMS and localized emergency signals. Signals can be received from remote sensors, local sensors and EMS input to warn and wake the occupants of a room, building or vehicle of an emergency situation and give proper instructions as to the safe egress.

### BACKGROUND

In most buildings some form of emergency warning system is constructed in order to alert, notify and otherwise warn the occupants as well ass emergency service providers. The typical warning system is a portable smoke detector and in more elaborate systems a hardwired network of smoke detectors and sprinkler systems. Thermal sensors, burglar detectors, as well as CO detectors and moisture detectors can accompany the warning systems in an attempt to protect the owners and occupants of the building.

There also exist public warning systems for the dissemination of information inhabitants of impending dangers. The systems can include the detection and warning for tornadoes, hurricanes, flash floods, tidal waves, severe thunderstorms, earthquakes and even potential public risk for large industrial complexes such as chemical facilities and nuclear power stations.

The above diverse system intended for alerting and providing help to people and property are not integrated. The warning systems are localized to individual buildings on a block, separate counties in a state, localized communities that contain or abut a facility and yet none are commonly tied into a network that can disseminate the information cohesively from the macro scale, such as county and statewide, down the macro scale, such as building, floor and room.

Additionally, the localized systems currently used to alert people are not comprehensive and omit portions of the population that cannot effectively rely on those limited systems for aid. For example, it is now understood that the standard household smoke detectors is not effective at waking sleeping children under the age of 5, nor the elderly. The hearing impaired is effected across all age groups. The smoke detector is the first line of defense in the residential dwelling and is often exclusively relied on by millions of people.

What is needed in the art is a comprehensive interconnected emergency alert system that deploys multiple means of alert.

### SUMMARY

The disclosed device is directed towards an emergency alert delivery system including the integration of multiple systems.

### BRIEF DESCRIPTION OF DRAWINGS

FIG. 1 is an illustration of an exemplary Alert CPU.

FIG. 2 is a multi-view illustration of an exemplary Alert Device.

FIG. 3 is a multi-view illustration of an exemplary Safety Receptacle.

FIG. 4 is a multi-view illustration of an exemplary Safety Receptacle.

FIG. 4A is a multi-view illustration of an exemplary Safety Receptacle.

FIG. 5 is a multi-view illustration of an exemplary Alert CPU and Plate.

FIG. 6 is a multi-view illustration of an exemplary self generating alert device.

FIG. 7 is a multi-view illustration of an exemplary programmable appliance with auto tune and auto override.

FIG. 7A is a multi-view illustration of an exemplary programmable appliance with auto tune and auto override.

FIG. 7B is a multi-view illustration of an exemplary programmable appliance with auto tune and auto override.

FIG. 8 is an illustration of an exemplary smart smoke detector.

FIGS. 9 and 10 are illustrations of exemplary sets of incoming and outgoing signals.

FIG. 11 is an illustration of an exemplary fire situation.

FIG. 12 is an illustration of a multi-unit scenario.

FIG. 13 is an illustration of a multi-level building scenario.

FIG. 14 is an illustration of an exemplary regional sensor alert system.

FIGS. 15 and 16 are illustrations of a county central alert system.

FIGS. 17 and 18 are illustrations of an exemplary air mattress.

FIG. 19 is an illustration of an exemplary valve.

FIG. 20 is an illustration of an exemplary cord and hose keeper.

### DETAILED DESCRIPTION OF THE INVENTION

Persons of ordinary skill in the art will realize that the following disclosure is illustrative only and not in any way limiting. Other embodiments of the invention will readily suggest themselves to such skilled persons having the benefit of this disclosure.

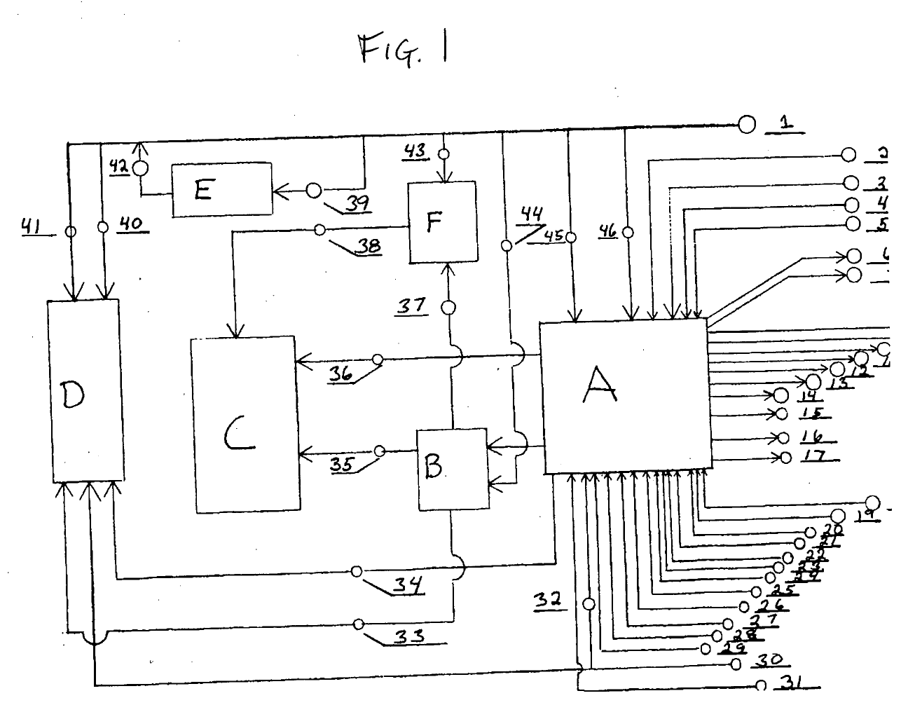

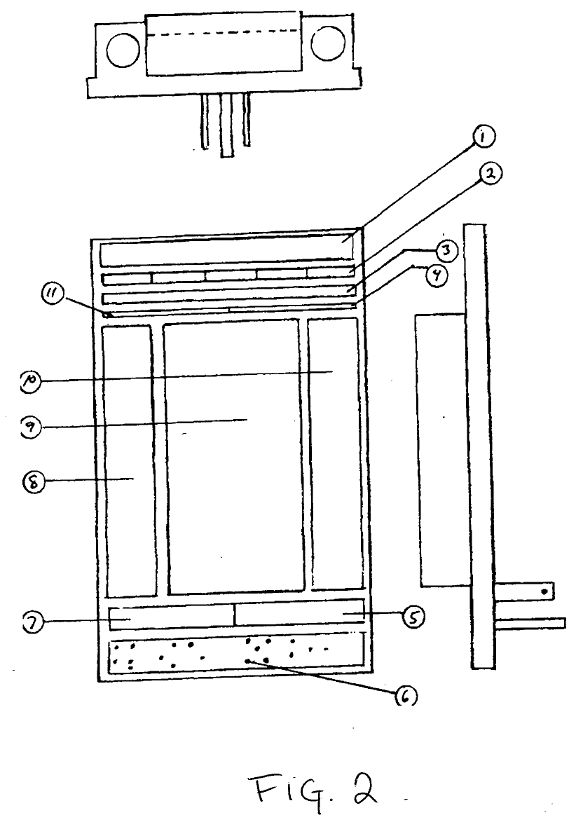

Referring to FIG. 1 an exemplary automatic trip and trigger CPU is illustrated. The Alert CPU A includes a main override coupled to various components. An override automatic tuner B having preset channels and stations is coupled to the Alert CPU A. The override automatic tuner B can be employed to provide emergency information in the event of an emergency.

When activated, the override automatic tuner B automatically tunes to an emergency channel set for emergency broadcasts, overriding the present program tuning. An appliance C is coupled to the CPU A to allow for an alternate method of alerting the occupants as well as for being controlled by the Alert CPU A in order to provide an independent alert. The independent alert device D can include but not be limited to speakers, lights, signals and indicators that provide information to occupants. A backup battery E is coupled to the Alert CPU A. The backup battery E provides additional electrical in the event that normal power is not available. A remote control and sensor unit F is couple to the Alert CPU A and provides an alternative means of activation of the Alert CPU A. A variety of sensors for motion, fire, carbon monoxide, infrared light detectors and the like, can provide signals that can activate the Alert CPU A.

The Alert CPU A includes many inputs as seen in A. The Alert CPU A can include atmospheric devices as input devices to sense and determine the conditions of the atmosphere both locally and remotely. A variety of personal communication devices can provide input to the Alert CPU A to activate and deactivate the system. Remote signals can activate the Alert CPU A. Then signals can be developed from radio, cell phone and smoke detectors from inside the building. Emergency service providers can activate the Alert CPU A. A fail safe backup signal can also be developed to activate the Alert CPU A.

The Alert CPU A can develop many signals the activate the periphery components in the system. The initial alert signal 34 can be generated from the Alert CPU to the system grid. The Alert CPU can activate the independent alert devices, such as a local smoke detector as well as smoke detectors throughout the building. The Alert CPU A can divert power or shut down power to local power outlets or entire electrical grids. Redundant systems can be employed that provide backup signals, power and activate the emergency alert delivery system 100.

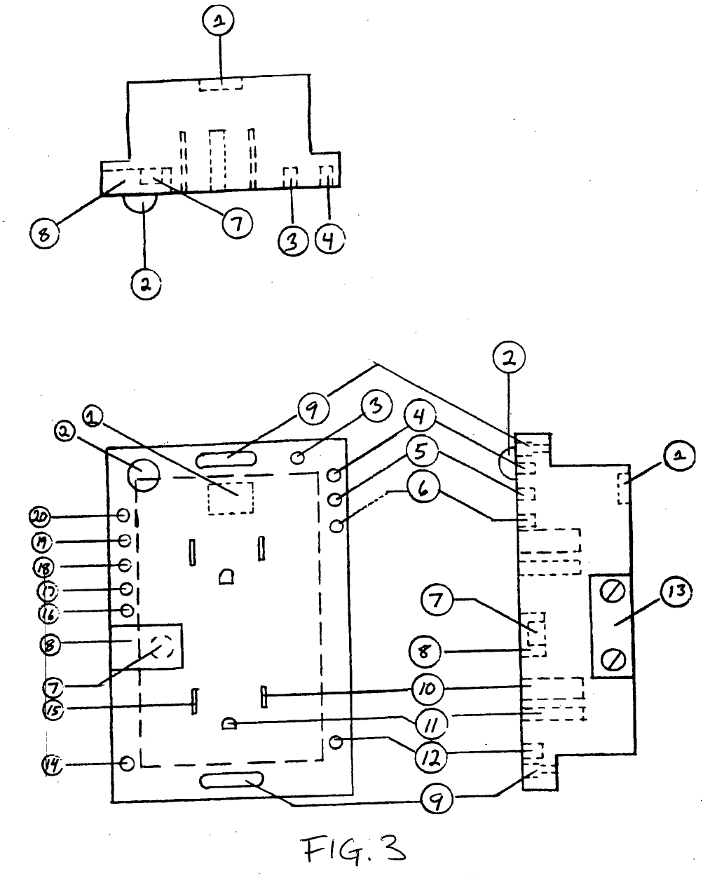

Referring to FIG. 2, an integral component in the emergency alert system 100 is an alert device 110. The alert device 110 is a plug in unit that plugs into an electrical outlet or other power source. The alert device 110 is configured for installation at wall outlets in rooms of buildings and various locations where power is available even portable power sources, such as automobiles, airplanes, boats and the like. The alert device 110 includes multiple features that enhance the capability of the emergency alert delivery system 100 to operate. The alert device 110 includes a display 1, preferably a digital display. The display can present messages that can be read or viewed by an occupant, allowing the occupant to be informed of impending danger. The alert device 110 includes a color-coded grid 2 that provides color-coded signals to the occupants. The color-coded grid 2 can alert an occupant based on a predetermined color code. For example, the color-coded grid can include a red, green and yellow portion. The red can indicate a high alert, the yellow can be a medium alert and a green is all safe. A strobe light 3 can signal an occupant that an alert has been activated. A microphone 4 can be included to allow for person remote from the location of the alert device to listen to audible information. The occupant can have two way communication through the microphone 4 and speaker 11. An anti-rodent and anti-pest device 5 can be included to ward off unwanted pests from the location of the alert device 110. Braille signage 6 can direct a blind occupant. A camera 7 can be included in the alert device that allows for surveillance of the location of the alert device 110. The camera 7 can be used to indicate conditions of the area near the alert device 110. An air cleaner 8 can be included with the alert device 110 to condition the air at the location. A night-light 9 can be included with the alert device 110 to provide better night visibility. The alert device 110 can also include an air freshener 10 that dispenses a scent into the air at the location of the device 110. A speaker 11 can be included with the alert device 110 to provide audible signals such as voice commands and warnings to the occupants. A parent's voice can be broadcast from the speaker with a message to an occupant, such as a child, to wake up and leave the room in the event of an emergency. The alert device can include a laser direction indication configured t emit a visual indication of a safe exit. If in plugged, the alert device 110 emits and audible warning to prevent and discourage theft and tampering. The alert devices can be used as an intercom system. As described above the alert device can be portable. In an exemplary embodiment, the alert device 111 can be employed in a vehicle 112. The alert device 111 can include sensors that sample the outside air and process the data from the sample. If a dangerous air sample is detected, the alert device 111 can shut down air dampers isolating the indoor air from the outside air, and activating the emergency alert delivery system 100. Windows can be automatically closed and escape routes posted in a heads-up display or can be integrated onto currently existing navigation displays. The alert device 111 can be integrated into currently existing automobile remote safety networks (e.g. ONSTAR). It is contemplated that any type of vehicle can be used in concert with the alert device 111 in order to protect the passengers and any cargo.

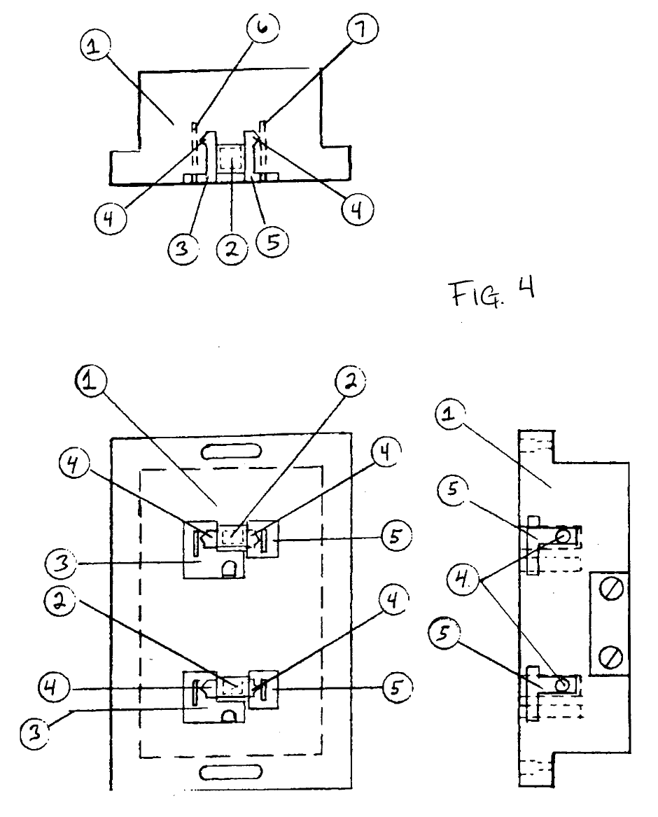

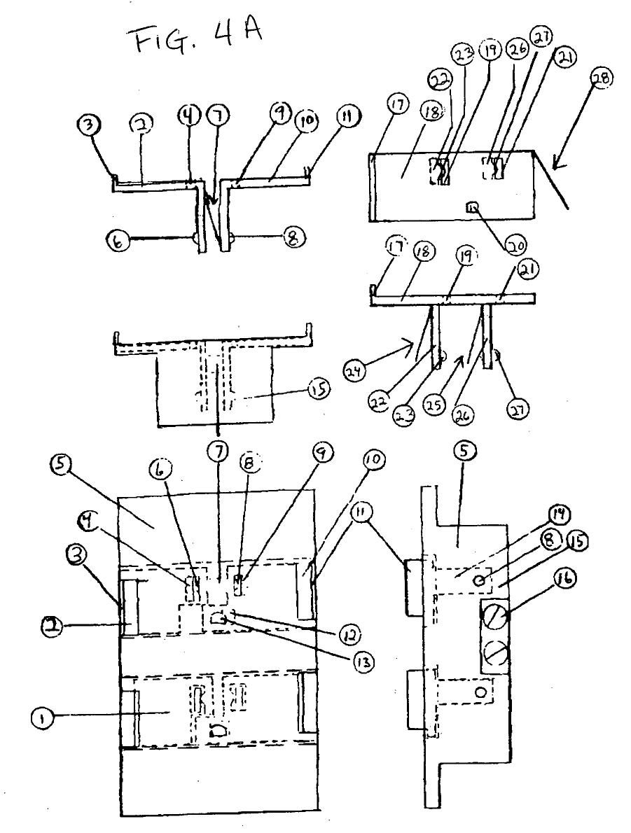

Referring to FIGS. 3, 4 and 4A, an exemplary safety receptacle 120 and plate is illustrated and described. The emergency alert delivery system 100 includes the plug in alert device 110 as well as incorporates and alert device that is hard wired into a wall. The safety receptacle 120 includes features of the alert device 110 as well as additional features. The safety receptacle 120 can include a directional indicator that indicates the direction of the nearest exit. The safety receptacle 120 also includes a laser device that projects an image indication an exit. A backup battery 7, 8 can be included with the safety receptacle 120. The safety receptacle 120 is configured with the mounting slots 9, plug spade receptacle port 10, plug spade common wire port 15 ground opening 11 and an incoming hot wire terminal 13. The array of indicators for alert 16-20 can be included with the safety receptacle to provide a visual indication warning an occupant of an emergency. Similarly to the above color coded scheme the array can provide different indication for varying levels of warning. Similarly to the above color coded scheme the array can provide different indication for varying levels of warning. The safety receptacle 120 can also include similar features to the above described alert device 110, such as a speaker, air sensor, night light, night glow material, microphone, micro camera, motion sensor, strobe light and the like. The safety receptacle 120 can include a locking pin, sliding door protection to prevent unwanted removal of items plugged in and to prevent objects from being inserted into the slots. The sliding door and the locking pin can be spring actuated, motor driven, magnetic actuated and any combination thereof. The locking pin can utilize the existing spade holes in the plug in spades. The locking pin fixes the plug in such that the spades cannot move in the receptacle, thus limiting arcing. A biasing member can bias the locking pins to maintain pressure and eliminate arcing due to loose contacts. Voice command features can be integrated into the safety receptacle 120 and the alert device 110 as well. The safety receptacle sliding door can be opened by remote control as well as by a sensor that opens the gate by sensing a plug equipped with an emitter. A manual locking pin and door body can be incorporated (See FIG. 4A). A single door body can be employed (See FIG. 4A, F).

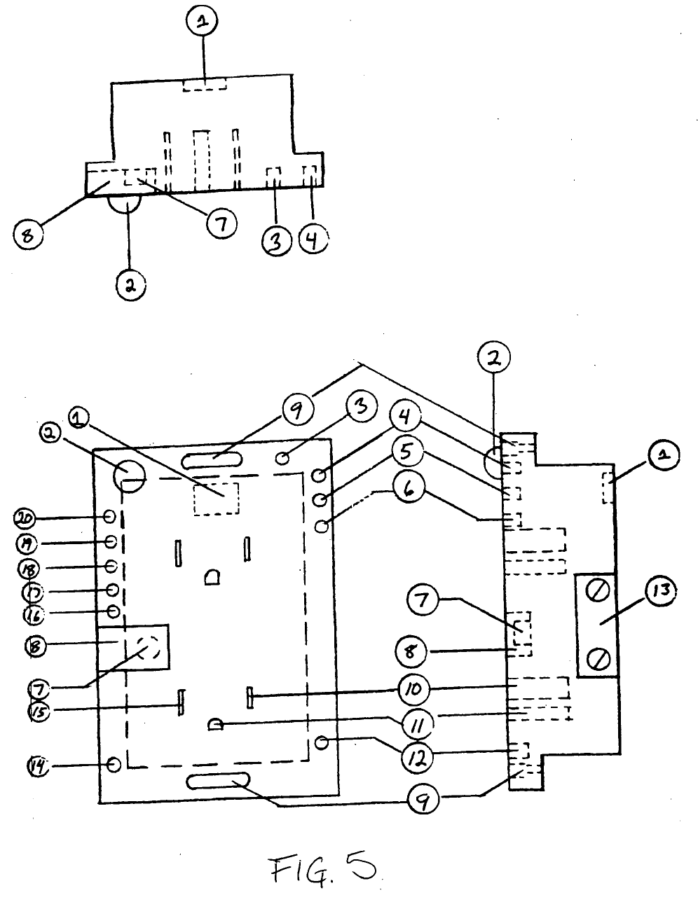

Referring to FIG. 5, an exemplary combination Alert CPU and plate 130 is illustrated. The combination Alert CPU and plate or simply Alert CPU 130 includes most of the features of the above described Alert device 110 and safety receptacle 120. A means for indicating an exit is incorporated in the Alert CPU 130. The means for indicating an exit can include the above described elements as well as included a laser light that projects an image visible to occupants indicating the exit location. Light and sound as well as physical means can be employed to indicate an exit. For example, the indication can be a physical direction arrow, or tactile means that, when touched points the way to the exit of the room. A whistle having a stream of air blowing through the whistle as well as a pop-up element that is extended with the air stream that can indicate a direction to follow is also deployable in the system. It is contemplated that the tactile features for the indication of the exit can be employed in the above described safety receptacle 120 and alert device 110.

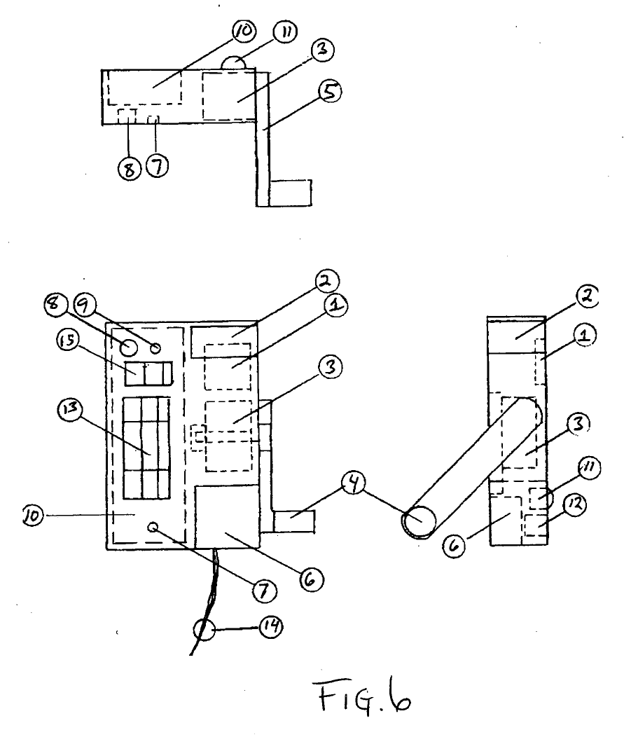

Referring to FIG. 6, an exemplary self generating alert device is illustrated and described. The self generating alert device 140 includes all of the features of the alert device 110 and safety receptacle 120 and alert CPU 130. The self generating device 140 includes a signal receiving and distributing unit 1 that provides communication features between the self generating alert device 140 and the other components in the emergency alert delivery system 100. The additional components of the self generating alert device 140 are equipment for generating electrical power. The self generating alert device 140 includes a generator that is manually operated. The generator 3 can be hand cranked through a rotary and crank 5 or in an alternative embodiment, the generator 3 can be manually operated with a crank that is activated by a hand squeeze. The hand squeeze utilizes two opposing grips that can be manipulated and brought close together by a hand squeeze. The self generating alert device 140 allows for use of the emergency alert delivery system 100 when the power to the local alert device 110, 120 and 130 is no longer available. The self generating alert device 140 can integrate into cellular communication systems as well as pager systems.

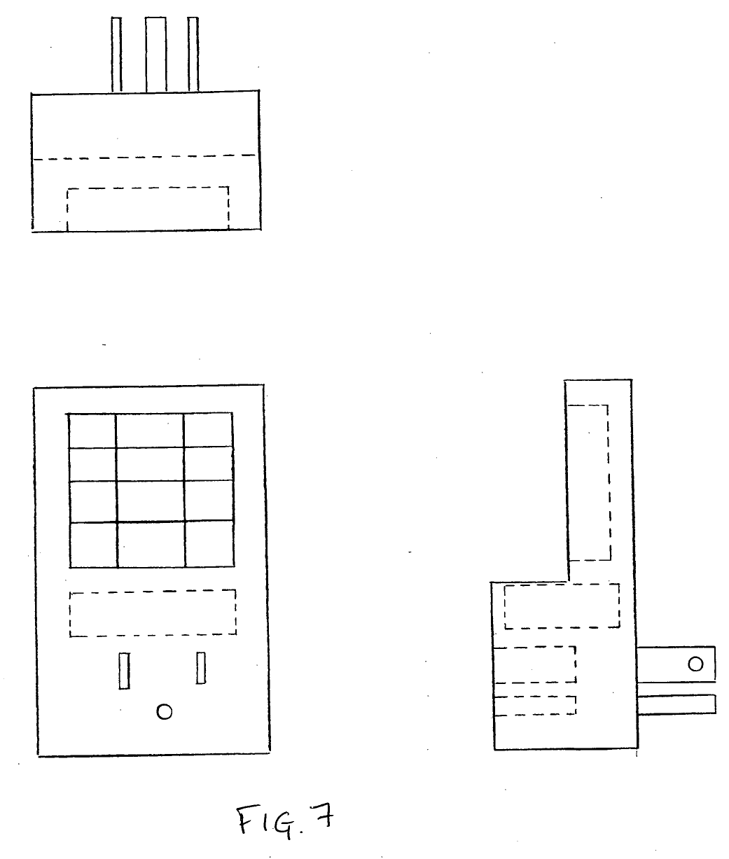

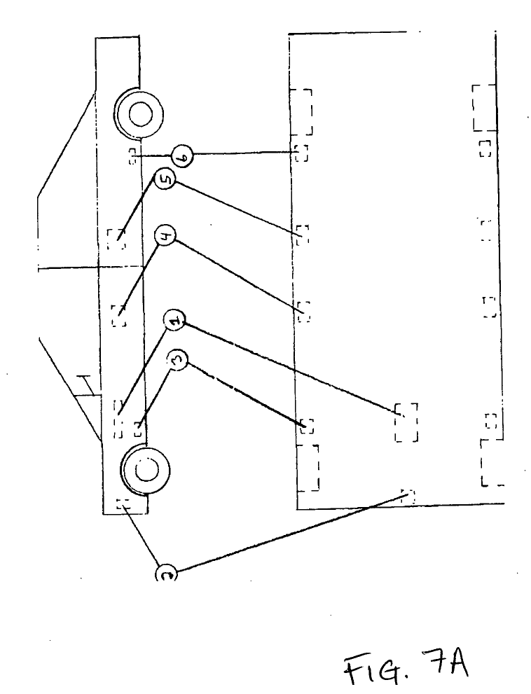

Referring to FIG. 7, an exemplary embodiment of a programmable appliance with auto tune and auto override 150. The programmable appliance with the auto tune and auto override 150 includes a unit housing 1 with a keypad 2. The programmable appliance with the auto tune and auto override 150 is configured to automatically turn on and turn off appliances coupled to the programmable appliance with the auto tune and auto override 150. The keypad 2 can be used to enter data for programming the programmable appliance with the auto tune and auto override 150. The programmable appliance with the auto tune and auto override 150 includes a signal receiving and distribution unit for communications functions within the emergency alert delivery system 100. An electrical outlet is included with the housing to allow for appliances to plug into the unit in order to provide for control of the appliance. The unit can also communicate through wireless to multiple appliances in order to provide command and control functions of the appliances. An exemplary appliance is illustrated at FIG. 7A. The appliance 155 is configured with the capacity to receive alert override signals and automatically tune into alert warning commands and directives. The appliance 155 can be a stereo, television, car audio equipment and the like. The warning indicator can be included to provide visual levels of warning.

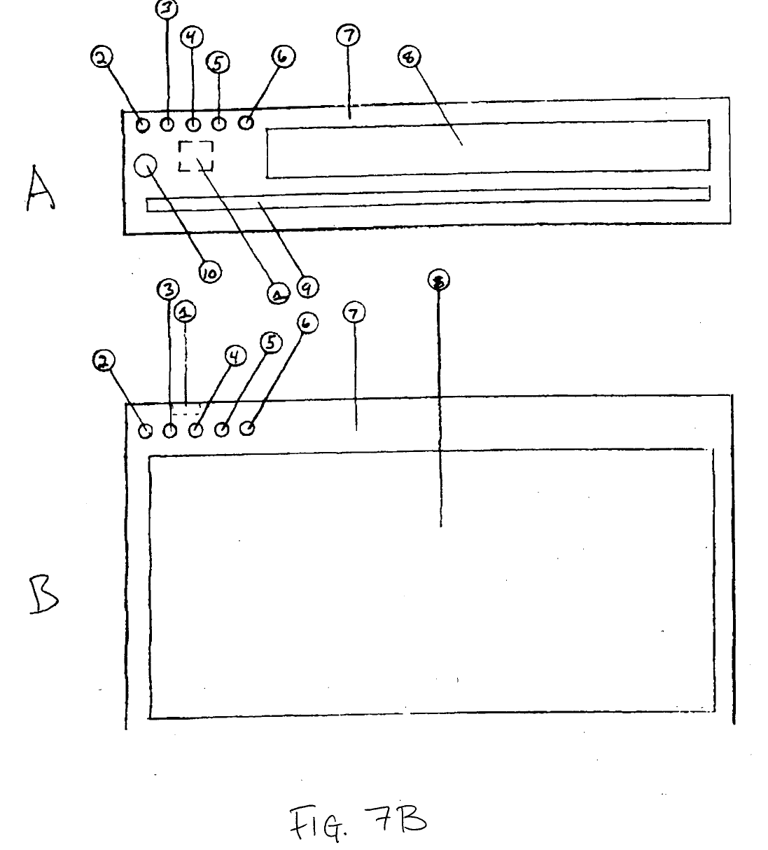

Referring to FIG. 8, an exemplary smart smoke detector is illustrated. The smart smoke detector 160 includes the features of a smoke detector, (I.e., smoke sensor, audible alarm, power source and battery backup). The smart smoke detector 160 also includes a signal receiving and distribution unit configured to send and receive communication information to and from remote locations via wireless and hard wire means. The smart smoke detector 160 is coupled to the other devices within the emergency alert delivery system 100. The smart smoke detector 160 couples to the alert device 110 and safety receptacle 120 and alert CPU 130 as well as the programmable appliance with auto tune and override 150. The smart smoke detector 160 senses smoke, CO, and other potentially harmful gases. The smart smoke detector 160 can detect heat as well as other indicators of fire.

The smart smoke detector 160 identifies the location of the fire within a building. The smart detector 160, and other alert devices 110, 120, 130, 140 and 150. The smart detector 160 is configured to emit audible alert sounds, such as a horn, a voice message, and any audible sound that can warn. The smart detector 160 can even utilize the recorded voice of a parent urging a child to wake up and exit the building. The smart detector 160 is equipped with a processor that receives inputs of fire location, generates outputs for the best exit of a room and a building as well as communicates with the emergency providers directly. The processor can also generate commands to appliances, power supplies, utility supplies such as natural gas, and shut down the potential sources of fuel and hazard. The smart detector 160 includes visual indication, such as a strobe light. The smart detector 160 can be equipped with a camera to provide visual inputs from the location. The smart detector 160 is positioned. The visual data can aid emergency response personnel in rescue and fire fighting. The smart detector 160 can include other forms of sensors that can detect motion or heat or sound to improve data gathering for the conditions of the room, presence of people or property and the like. The smart detector 160 can be incorporated into the bathroom exhaust fan units, attic fan and the like.

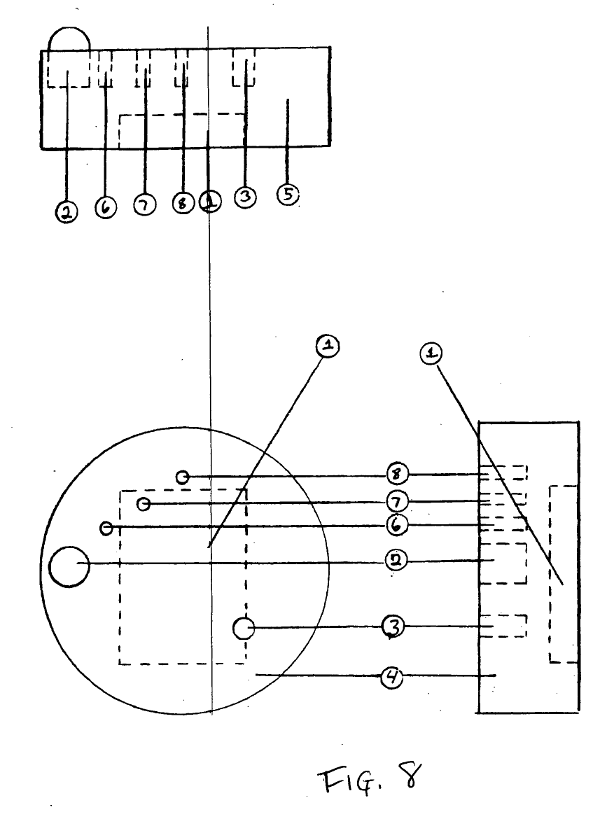

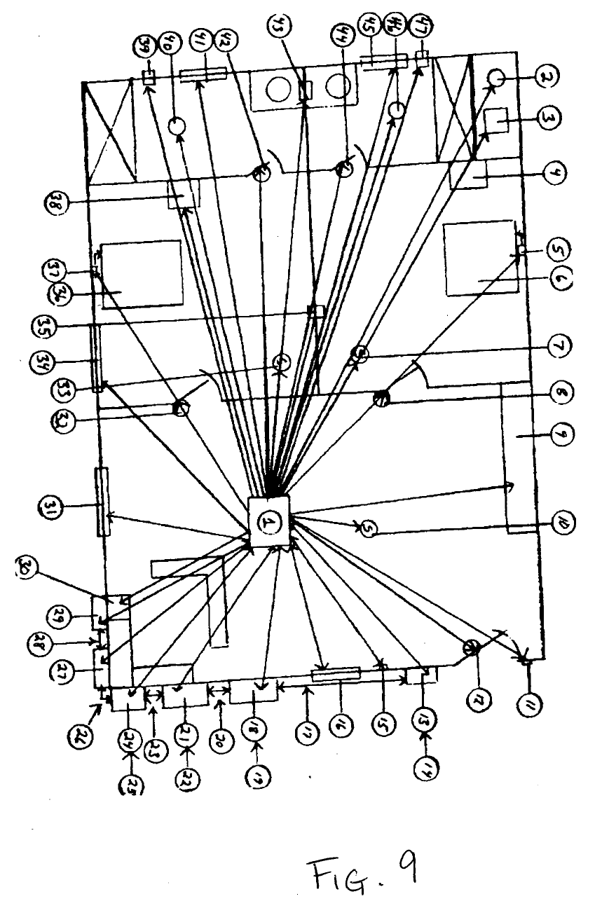

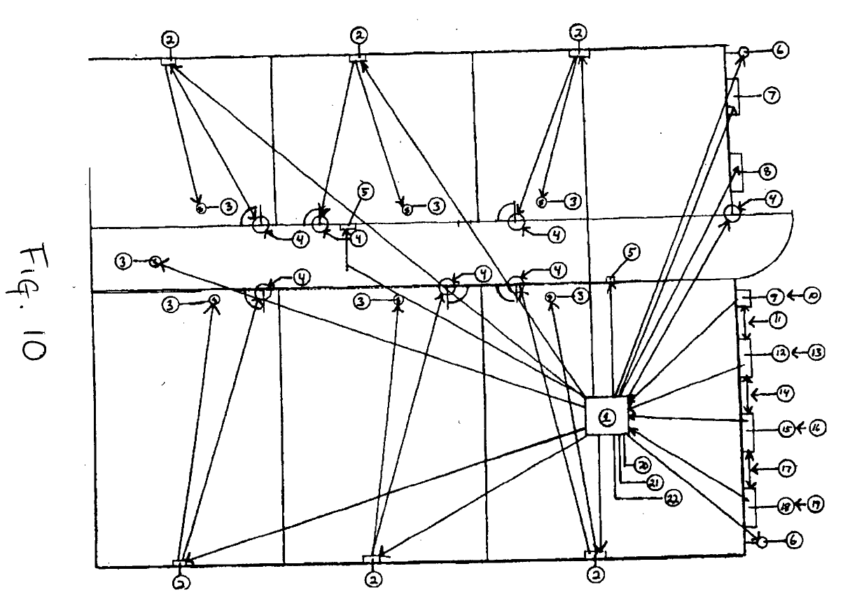

Referring to FIGS. 9 and 10, an exemplary set of incoming signals and outgoing signals are illustrated. The incoming signals 170 are examples of representative inputs that the emergency alert delivery system 100 would receive. The outgoing signals 180 are examples of representative outputs that the emergency alert delivery system 100 would deliver. The emergency alert delivery system 100 receives many signals that activate components, alert auxiliary systems, and direct the system to perform various control functions. FIG. 9 illustrates an exemplary location having rooms with windows and appliances installed. The location includes the installation of the alert devices 110, 120, 130, 140,150 and 160. The alert devices are in operative communication and are coupled to activate and deactivate building components. The building components are too numerous to list, so examples are provided to teach the invention in the spirit of brevity.

As an example, in the event of a chemical spill on a highway near the building having the emergency alert delivery system 100 installed, the emergency alert delivery system 100 can activate and react. The sensors of the alert devices 110,120,130,140,150,160, can detect the fumes of the chemical spill. The emergency alert delivery system 100 can also receive inputs from area emergency response providers, such as the state police and fire departments. The information can be received by cable, radio, wireless direct transmissions and the like. The information is processed and commands are generated. The system 100 activates and deactivates the various appliances and building systems in order to provide the maximum protection to occupants. The radios, televisions, telephones are activated To indicate an emergency has taken place as well as provide details regarding the chemical spill, wind direction and the other information necessary to respond to the emergency. Ventilation system dampers to the outside air are closed. Windows and doors are closed. The alert devices also indicate places of safety and of impending danger. The emergency alert delivery system 100 reacts to the emergency with predetermined procedures, as well as through programmed reaction commands based on system inputs and the nature of the emergency.

The emergency alert delivery system 100 also provides outputs that can bolster the local emergency response network as well as provide pertinent data for emergency response providers.

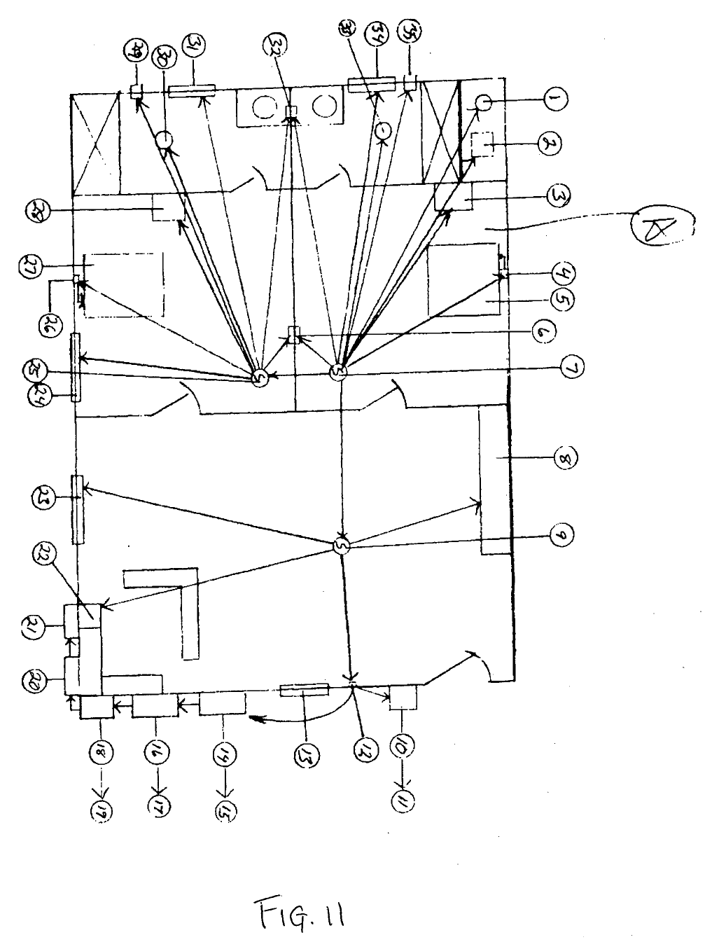

Referring to FIG. 11, an exemplary fire situation illustrated. The emergency alert delivery system 100 can be installed at various locations. The example illustrated in FIG. 11 presents a fire scenario. The emergency alert delivery system 100 described herein is configured to respond to many emergency situations, the fire situation is for teaching and does not limit the disclosure. At FIG. 11 a plan layout of a unit 1 having rooms 2-12 separated by walls and doors. The unit includes alert devices 14 installed in the rooms. Sensors are installed in the rooms. The unit 1 also includes building systems 3, such as electrical power, HVAC, natural gas for the HVAC. The alert devices 14 are coupled to the sensors 16. A signal receiving and distribution unit 18 is an operative communication with the alert devices 14 the signal receiving and distribution unit 18 is in operative communication with the building systems as well as emergency service providers 20 in the event of a fire in room 2, the sensors 16 in the room will detect the fire and transmit a signal containing information to the alert device 14 in the room 2. The alert device 14 can also detect the fire of so equipped. The alert device 14 sends out signals to the other alert devices 14 and to the signal receiving and distribution unit 18. The alert devices 14 in the unaffected rooms 4-12 send signals with information to the signal receiving and distribution unit 18. The signal receiving and distribution unit 18 can Process the information from the alert devices 14 and sensors 16.

The signal receiving and distribution unit 18 then can generate commands to the alert devices 14 and the building systems 3. The signal receiving and distribution unit 18 can designate codes on the indicators of the alert devices, indicate a safe exit, provide warning and alert information describing the location of the fire in room 2 as well as the best route of escape from each room. The information from the signal and distribution unit 18 can also activate fire protection systems, close windows, close dampers in ducts, cut off electrical power, shut down natural gas and the like. The signal receiving and distribution unit 18 can communicate with other units in the building and in the neighborhood as well as the region and state.

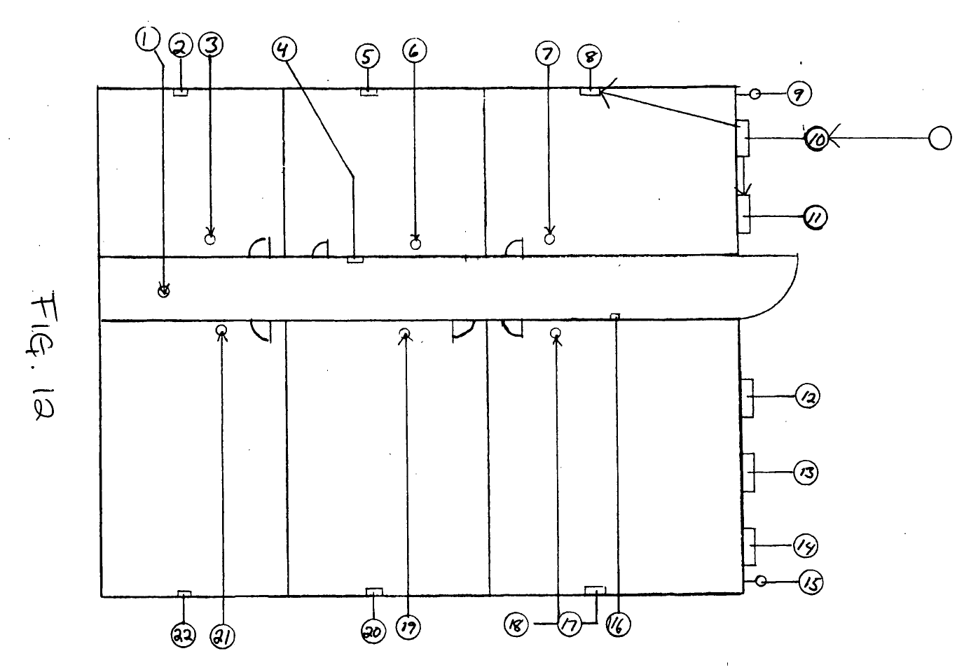

The emergency alert delivery system 100 can also communicate with another unit 5 and provide signals to direct the building systems 3 in the unit 7 to react to the fire in unit 1. FIG. 12 provides the illustration and description of the multi-unit scenario. As the emergency alert delivery system 100 is activated by the fire in unit 1 the system communicates with other units, such as unit 7 in FIG. 12. The incoming signal receiving and distribution unit 18 are processed by the signal receiving and distribution unit 1 of unit 7. The signal receiving and distribution unit 1 activates various building systems. Water is shut down, the doors are closed, gas is shut off, outdoor lights are flashed to provide an indication of an emergency. The signals can be transmitted along the telephone system lines, by wireless, along the electrical power system lines and the like.

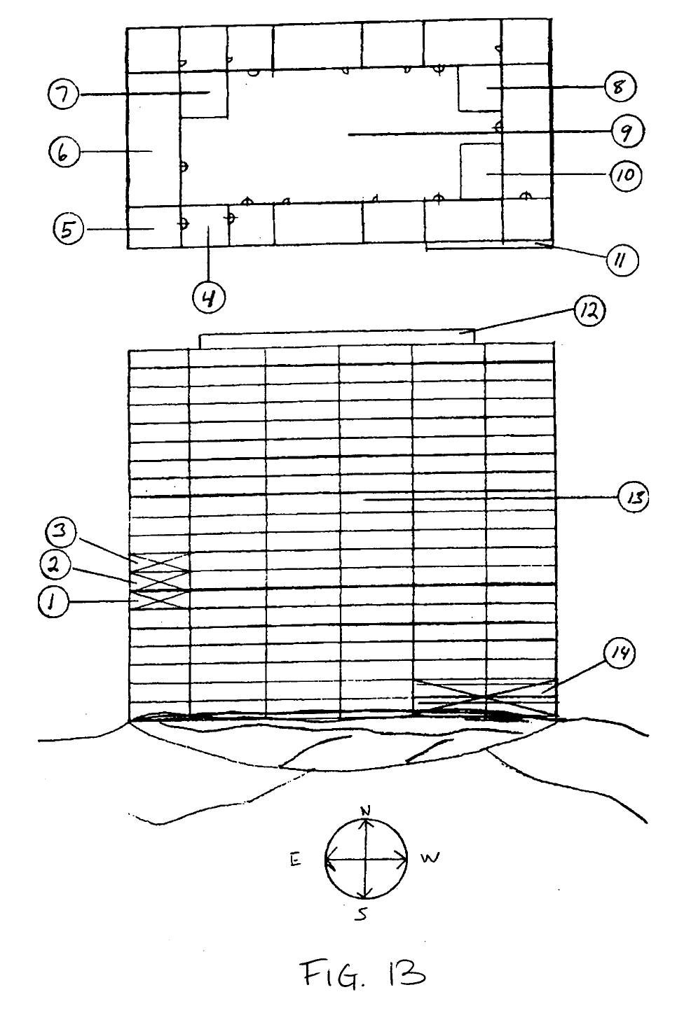

Referring also to FIG. 13, the emergency alert delivery system 100 shows the scenario with a multi-level building 30 from plan and elevation views. As the fire in unit 1 or for this example the southeast corner of level 7 number 5 of building 30, the emergency alert delivery system 100 activates. The emergency alert delivery system 100 receives the information gathered by all of the alert devices in all the rooms on all levels. The information is used to generate emergency procedures with in building 30. The emergency alert delivery system 100 activates the alert devices wherein best route of exit indicated, areas that are unsafe are indicated, the emergency service providers are alerted and provided with details of the fire and building system 30 conditions. The elevators, stairwells, lobby and other sections of the building can be secured and scanned for occupancy as well as illuminated and cleared or shut off for the occupants to safely evacuate the building 30. The emergency alert delivery system 100 can also be equipped with fresh air for breathing. The emergency alert delivery system 100 can also be equipped with fresh air centers that provide safe haven in the building that include a source of fresh air for breathing. The emergency alert delivery system 100 can direct occupants trapped in a smoke filled room to safe havens with fresh air. The safe haven can include communications centers that allow for occupants to communicate with emergency personnel.

The safe haven fresh air unit can include supplies of oxygen to improve the life saving capacity of the air supply. Safeguards can be included with the fresh air system to starve the fire and supply the occupants. Fire doors are activated as well as fire suppression systems. Since the alert devices are located in virtually every wall outlet, switch cover and smoke detector, and electronic appliances, the occupants have the access to the indicators and communication equipment to allow for two way communication with safety personnel as well as access to information to enable the occupants to make informed decisions to get to a safe area to be rescued.

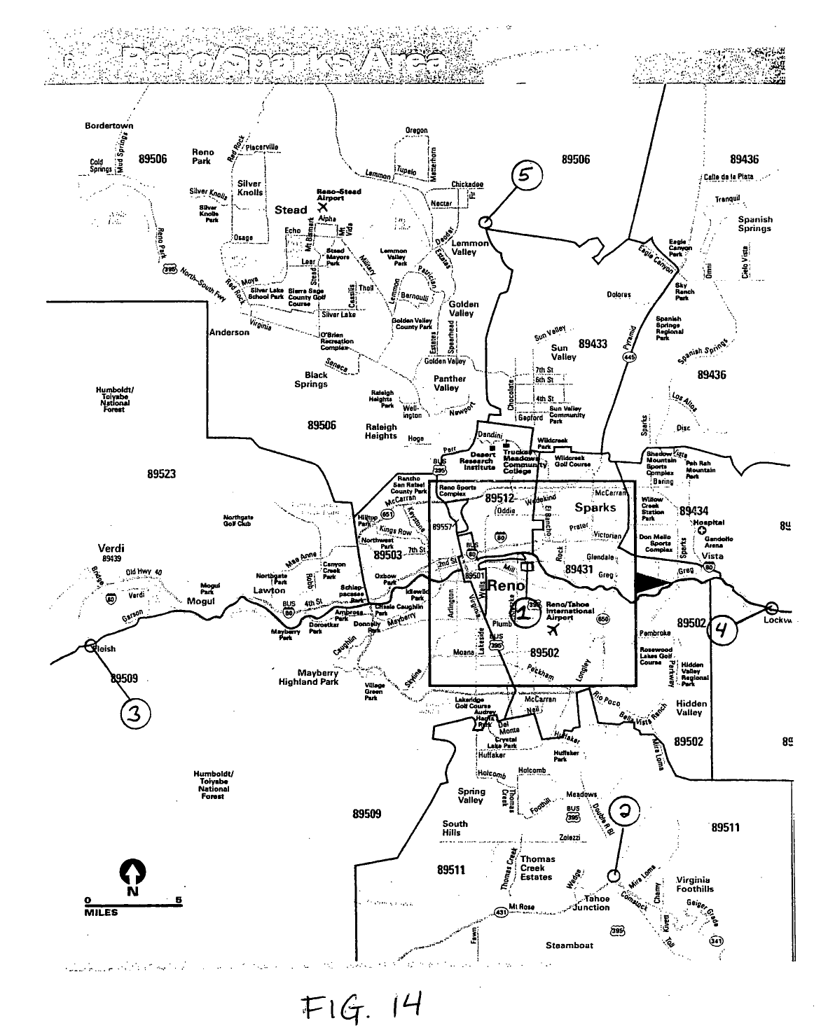

Referring also to FIG. 14, an exemplary regional sensor alert system is illustrated. The regional sensor alert system 200 integrates within the emergency alert delivery system 100 and covers a broader area. The above described building system and room system and individual alert devices all integrate into the larger regional alert system 200. The regional sensor alert system 200 includes the alert devices, room devices and systems and building systems and devices and incorporates a central receiving and distribution center. The central receiving and distribution center coordinates the emergency situations over the entire region. The regional alert system 200 also incorporates means of indication 2, 3, on larger. The means of indication can include streetlights that strobe or oscillate as a from of visual signal. Independent strobe lights can also be employed along with the streetlights. The use of the roadside lighted information boards can be incorporated into the system to provide visual indication, providing information about emergency situations in the region. The public loudspeaker system can include tornado warning sirens, nuclear power station failure, fire stations sirens and the like, If f, for example there is a chemical spill on the highway that passes through a region, such as a city, the regional alert system 200 having regional sensors, can detect dangerous gases from the spill and rapidly alert the remainder of the emergency alert delivery system 100. The system will communicate within the region, to buildings to floors to rooms and to each alert device. Building systems can be activated. The damage that could occur can be mitigated by use of the emergency alert system 100.

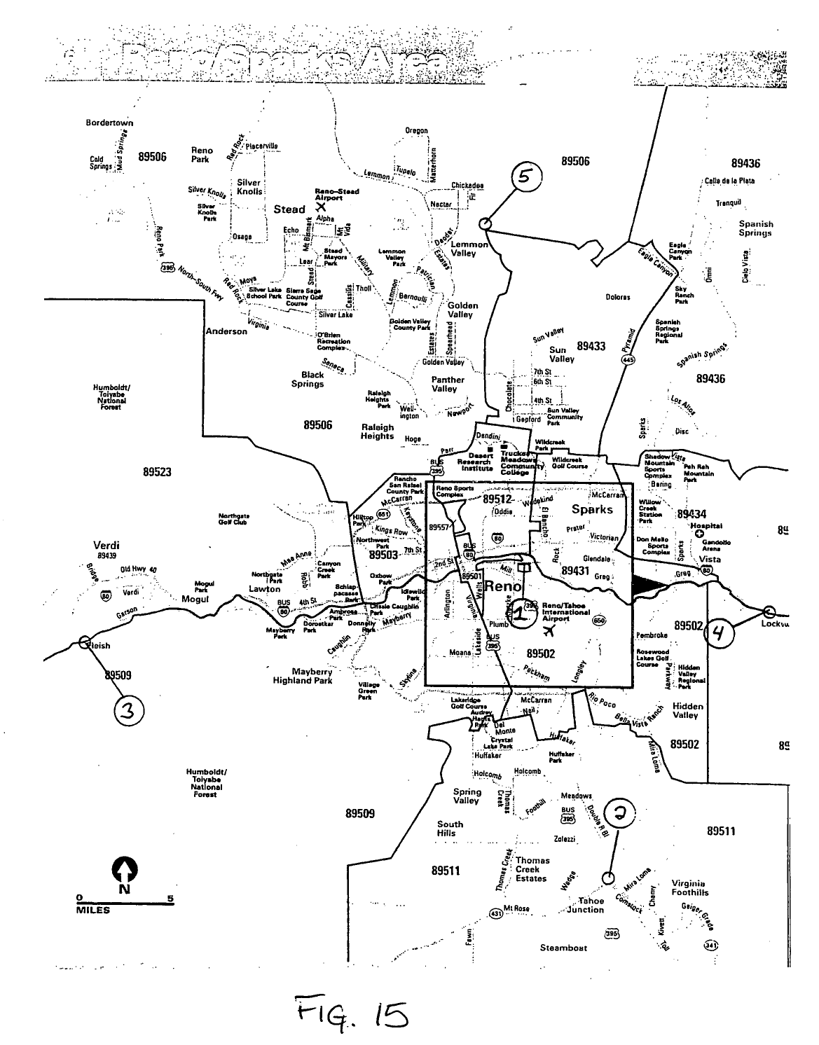

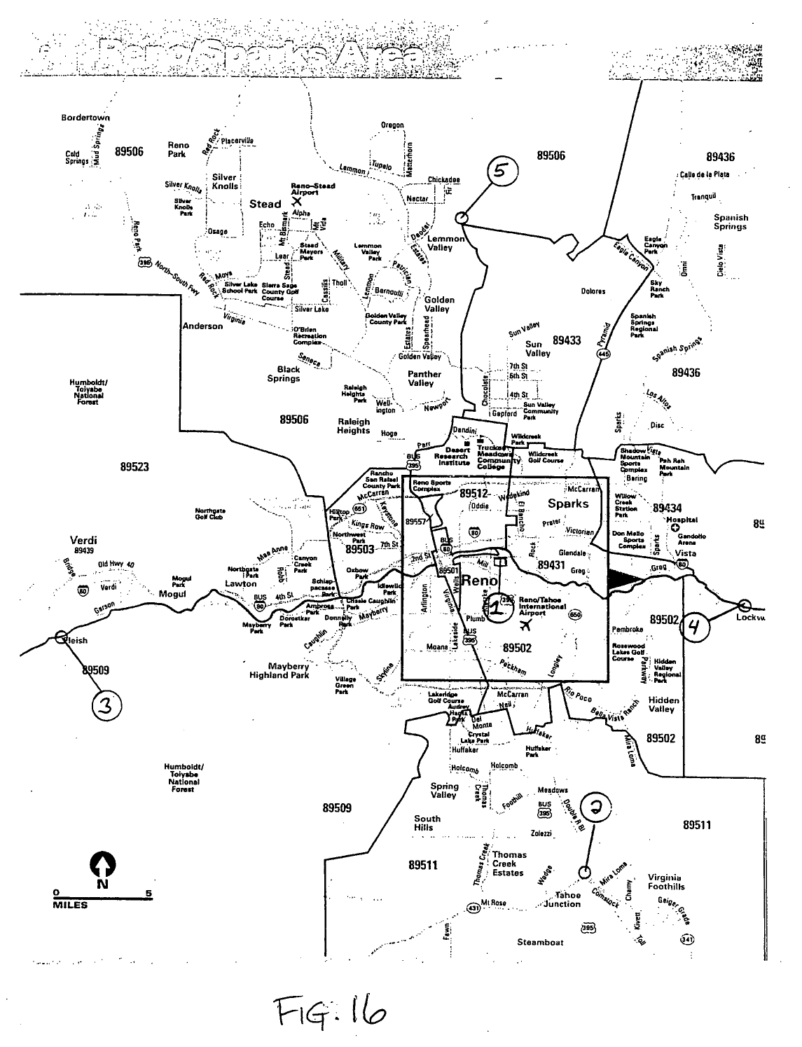

Referring to FIGS. 15 and 16, a county central alert system 300 is illustrated. The county central alert system 300 incorporates all of the features of the above described systems and expands the scope of interconnectivity throughout the entire county, state, or multistate area. A network of communication control and command units can be distributed throughout a county, state or multi-state that both communicate information as well as sense data. The sensors collect information from the atmosphere, earth and ocean or significant body of water. Distribution towers can be interconnected to the county central alert system 300. The information boards along the highway can be overridden and alert information can be visually displayed warning of dangers and directing people to safe areas. The building systems can be activated and place in safe conditions prior to the impending dangers arrival. The example illustrated at FIG. 16 is a factory explosion. The emergency alert delivery system 100 can be activated at the county level and information can be relayed across the county to provide needed data that can activate safety systems and place buildings in safe conditions. Many naturally occurring disasters mitigated by use of the emergency alert delivery system 100, such as earthquake, tornado, wild fire, tidal wave and the like. The emergency alert delivery system 100 can tie into national systems such as national weather reporting systems; to include weather related data into the response. Police, fires and other protection agencies can also provide input into the emergency alert system 100. The emergency alert delivery system provides a web of inter connected data gathering devices with a web of information transferring devices and processors that can activate life saving equipment, and building systems as one large integrated unit to react to emergency situations from the micro scale of a micro scale.

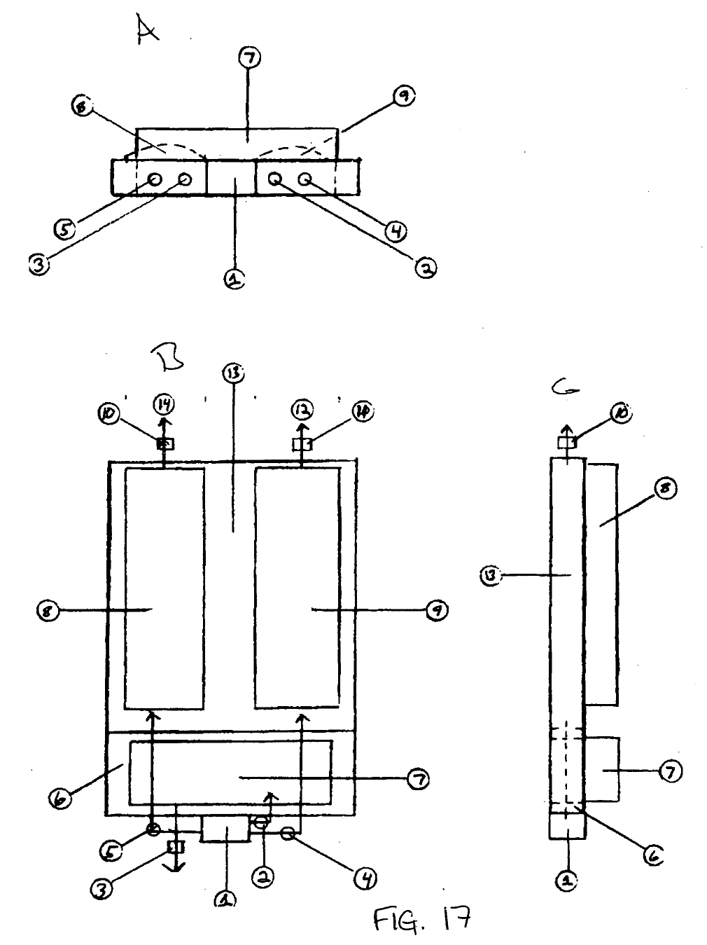

An example of a peripheral is an air mattress that is coupled to the emergency alert delivery system 100. FIG. 17 illustrates an exemplary air mattress 400. The air mattress includes a mattress frame structure 13, containing air pillows 7, 8, 9 coupled to air supply 1. The air supply 1 includes an air pump, controls and electrical power backup battery. The air supply 1 is coupled to the air pillows through a distribution network 2, 4, 5. A set of exhaust valves 3,10 and 11 includes a whistler unit that can create an audible alarm.

The air mattress 400 can be coupled to the emergency alert delivery system 100. When the emergency alert delivery system 100 has been activated, the emergency alert delivery system 100 can generate a command to activate the air mattress 400. An audible sound can also activate the air mattress 400 independently of the emergency alert delivery system 100. In normal conditions the air mattress 400 performs as a normal air mattress. The air pillow is adjustable by adding or removing air contained therein. When the air mattress 400 has been activated by the emergency alert delivery system 100, the air mattress 400 gyrates, pulses, flexes and otherwise creates motion to awaken and alert the person sleeping on the air mattress 400. Air pressure and air supply is alternated into and out of the air mattress pillows 7, 8, 9. The alternating or pulsing of the air in and out of the pillows 7, 8, 9, in any combination, creates a rocking and rolling effect on the air mattress 400. The air released through the whistler units 3, 10, and 11, creates an audible alarm.

In combination the physical motion and the whistle act to alert the person on the air mattress 400. An additional speaker and microphone can be integrated into the air mattress 400 to provide additional audible communications.

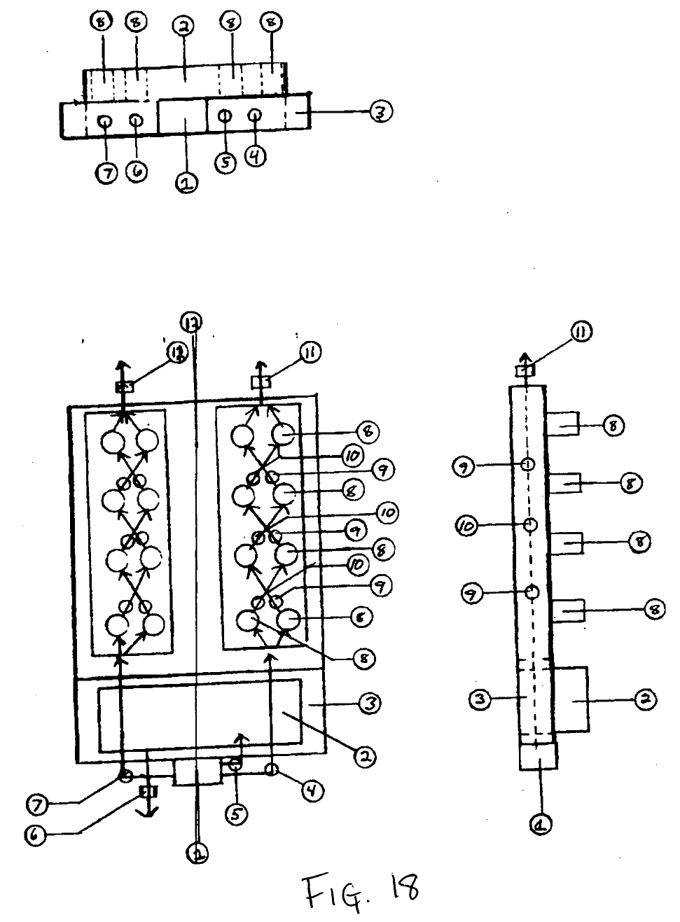

FIG. 18 illustrates an exemplary air mattress 500. An alternate embodiment of an air mattress 500 is shown including all of the components of the air mattress 400 with the addition of air cells 8. The air cells 8 are arranged in an array that can alternate along the air pillows 20, 22 and 24. The air cells 8 are fluidly coupled and include valves 9 that can open and close in an alternating pattern to create a pulsing or rocking motion along pillows 20, 22, and 24. Air is pulsed in and out of the air cells 8. The air cells 8 and valves 9 can be arranged in any pattern that provides for a pulsing motion along the air pillows.

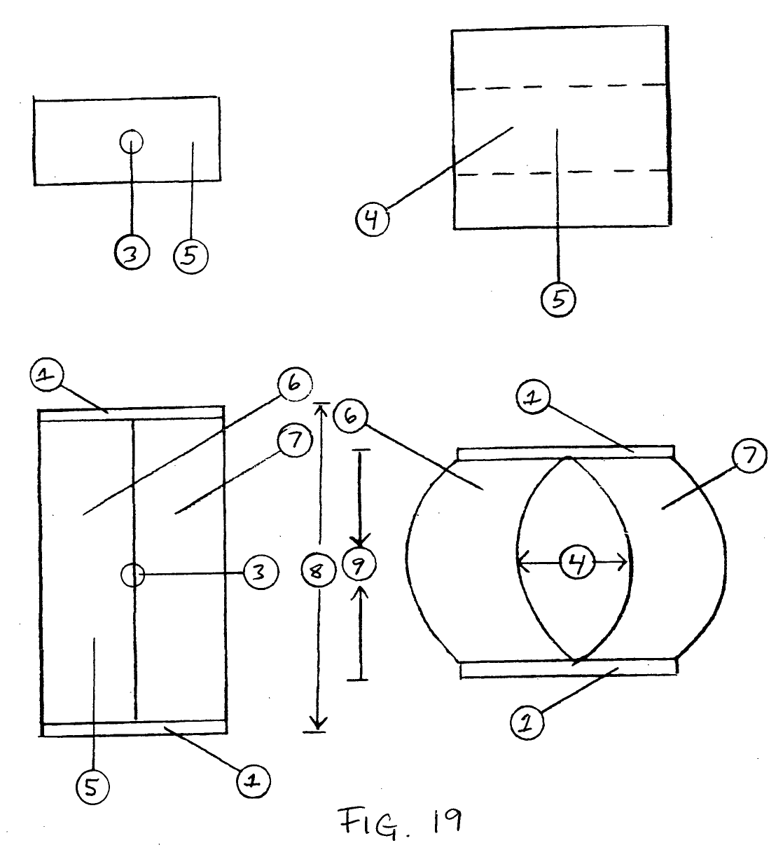

FIG. 19 illustrates an exemplary valve 600. The valve 600 includes a side structure 1 having two opposing members. The valve 600 includes a first gate 6 and a second gate 7 disposed between the opposing members of the side structure 1. The gates 6 and 7 comprise a magnetic material that also flexes. As the first gate 6 is given a magnetic polarity equal to the second gate 7 the first gate 6 and second gate 7 repel one another and create an orifice 4. The orifice 4 allows fluid to flow through the valve 600. When the first gate 6 and the second gate 7 are not polarized, the gates 6, 7 close tight together fluidly sealing. In another alternate embodiment, the first gate 6 and second gate 7 can be polarized as opposites and attract to one another. In this fashion they can seal against fluid flow. A biasing member (not shown) can be coupled to the gates 6, 7 to bias them closed or open. The gates 6, 7 can be polarized to overcome the biasing force and open or close. The shape or structure of the gates 6,7 can be formed, such that an inherent bias is developed that opens the gates 6, 7 or closes them. The magnetic polarity can be Activated to open or close the gates 6, 7. An electrical control circuit to be coupled to then gates 6, 7 to energize the material creating the magnetic polarity.

In another embodiment, the side structure 1 can be magnetically active. The side structure can be polarized to attract or repel each of the opposite members. The polarity of the side structure can be activated such that the opposite member attract. The gates 6, 7 can then be flexed apart and allow for fluid flow. The polarity can be changed to repel and the gates 6, 7 can be pulled together to seal. Electronics can be coupled to the side structure 1 to stimulate the magnetic polarity of the side structure materials. Any material that can be stimulated to generate a magnetic polarity is contemplated for the use with the valve 600. The valve 600 can be integrated into the above described air mattress 500 to allow the alternating flow of air. It is contemplated that a water mattress can be substituted for the air mattress with the addition of a water mattress reservoir to discharge and draw in water to the mattress during pulsation.

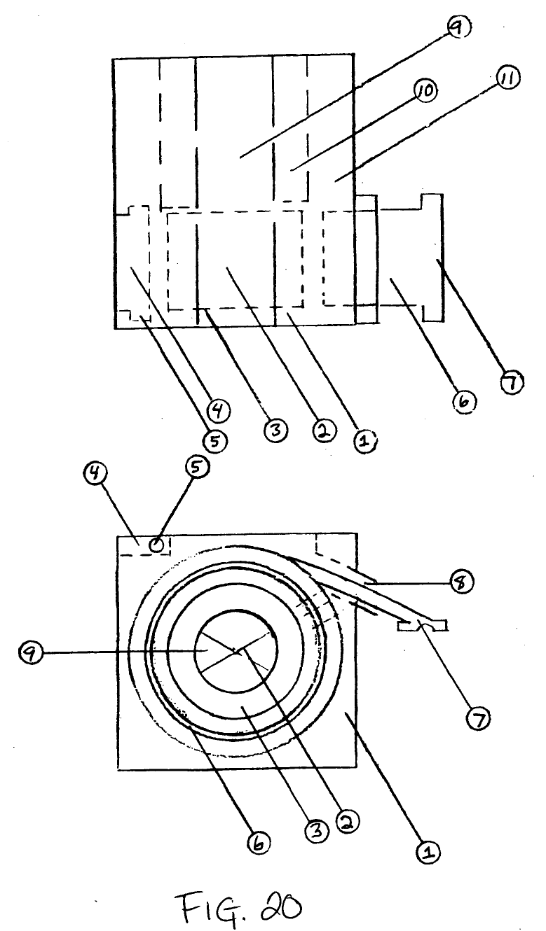

Referring now to FIG. 20, an exemplary cord and hose keeper is illustrated and described. The invention is a spring-loaded spool having a ribbon for wrapping (or fastening) around the cord (or wire or hose). Following wrapping of the cord, the user can write his/her name or other type of marking on the ribbon. FIG. 20 illustrates a cord keeper 700 having a housing 1 with a spring 2 disposed in the center of the housing 1. A spool 3 is disposed about the spring 2. A strap locking housing 4 is dispose din the housing 1 for connection of a strap 6 with a strap lock pin 5. The strap lock 7 is disposed in a strap opening for locking the strap 6. A wire (or hose or cord) 9 is dispose through the connector 10. A connector for at least 1 plug (or hose) 10 is disposed through the housing 1. In operation the cord keeper 700 is disposed over the cords outer diameter. The cord keeper 700 can be secured and remain proximate an end of the cord 9. When the cord 9 requires coiling for storage, the cord can be coiled in a coil as desired. Once the coil is complete the strap 6 can be pulled out of the housing via the strap lock 7. The strap 6 can be located on the housing such that the strap 6 is concentric with the cord or offset from the cord. An indicator loaded on the housing or the strap can be marked with a form of identification, allowing for the owner to maintain possession of the cord 9. The cord keeper 700 can be used with electrical power cords, water hose, air hose, rope, and any other cordage or tube material that is typically stored as a coil. In an alternate embodiment, the housing 1 can be mad integral with the ends of the cord, hose, tube and the like. The male and female ends of a water hose can be made integral with the housing 1 and the like. The cord keeper 700 provides for a means to store cords while providing means to identify the owner. In another embodiment, the housing can be clamped over the cord.

While embodiments and applications of the disclosure have been shown and described, it would be apparent to those skilled in the art of many more modifications then mentioned above are possible with out departing from the inventive concepts herein. The disclosure therefore is not to be restricted except in the spirit of the appended claims.

What is claimed is:

1. A CPU that has the following components:
A. Main override switch
B. Override automatic tuner with (preset channels and stations)
C. Appliance
D. Independent Alert Device
E. Backup Battery
F. Remote control sensor unit
G. Power source includes A/C or DC current and digitized FM signal
H. Programmed motion sensors
I. Carbon monoxide sensors
J. Fire detection and location sensors
K. Personal communication devices
L. Remote camera activation
M. Alert signal to all other devices
N. Alert to speaker
O. Signal to turn off/on gas
P. Delayed signal to shut off A/C main power source
Q. Activate strobe light
R. Alert EMS
S. Turns on emergency lighting
T. Test signal
U. False alarm reset
V. Electrical reactivation signal
W. Fail safe monitoring device
X. Radio signal monitoring device
Y. Phone signal monitoring device
Z. Cable signal monitoring device
AA. Cell phone signal monitoring device
BB. Smoke detector
CC. Remote sensors
DD. Satellite down link
EE. Personal communication device
FF. Emergency vehicles
GG. Emergency alert personnel
HH. Local and regional alert centers
II. National and global alert centers
JJ. Military
KK. Failsafe backup signal
LL. Military fail safe switch
MM. Secondary signal from tuner
NN. Alert level signal to grid
OO. Tuner signal to appliances
PP. Secondary power override
QQ. Override signal to remote control system
RR. Remote control signals
SS. Power supply to battery backup
TT. Digitized FM signal backup override
UU. Power supply for secondary emergency alert information device
VV. Backup battery supply
WW. Power supply for remote control system
XX. Tuner power supply
YY. Power supply to main override unit
ZZ. Digitized FM signal primary source.

2. A signal actuated air mattress that is a multi functional air mattress that alternates cycles into various air chambers. For emergency alert purposes, may also be used as a massager. These include:
A.1 Control unit
1. Air pump
2. Signal sensors
3. Battery backup
4. 12 volt backup with transformer
A.2 Pillow intake manifold distribution line
A.3 Pillow exhaust valve with whistler unit
A.4 Air intake manifold line, for pillow number 9
A.5 Air intake manifold line, for pillow number 8
B.1 Same as A1
B.2 Same as A2
B.3 Same as A3
B.4 Same as A4
B.5 Same as A5
B.10 Exhaust valve with whistler unit
B.11 same as B10
B.13 mattress frame structure
C. side profile

3. Air mattress number two is a multi air chambered, using pillow with multiple cone pillows with alternating cycles. May also be used as a back massager:
A. Back view
B. Top view
B.1 Control unit
Air pump
Signal sensors
Battery backup
12 volt backup with transformer
B.5 Pillow intake manifold line
B.4 Air intake manifold line for cone pillow number 8
B.9 & B.10 Alternating magnetic valve
B.11 & B.13 Exhaust valve with whistler unit
B.3 pillow frame structure
B.12 mattress frame structure
C. side profile
4. Alert Devices incorporated in Appliances
A.1 Power override switch
A.2 All ok indicator
A.3 Low level indicator
A.4 Next level indicator
A.5 Highest level indicator
A.6 Appliance housing
A.7 Stereo components
A.8 CD Door
A.9 Power switch
B.1 Power override switch
B.2 Thru 6 are same as A.2 thru A.6
B.7 TV housing
B.8 TV screen
B.9 Can include all safety alert functions.
